(19) United States
(12) Patent Application Publication
(10) Pub. No.: US 2026/0364999 A1
(43) Pub. Date: Nov. 19, 2026

(54) Distribution Module for a Thermal Management System, System Comprising a Heat Pump Having a Distribution Module, and Vehicle

(71) Applicant: ZF Friedrichshafen AG, Friedrichshafen (DE)

(72) Inventors: Axel Rohm, Schonungen (DE); Joel Kring, Hayingen-Anhausen (DE); Uwe Grossgebauer, Erlabrunn (DE); Detlef Gierling, Röthlein (DE)

(21) Appl. No.: 19/121,085

(22) PCT Filed: Sep. 12, 2023
(86) PCT No.: PCT/EP2023/074945

§ 371 Date: Apr. 14, 2025

(30) Foreign Application Priority Data
Oct. 14, 2022 (DE) 102022210903.1

(51) Int. Cl. B60H 1/32; B60H 1/00

(52) U.S. Cl. CPC B60H 1/32284; B60H 1/00485

(57) ABSTRACT

A distribution module has coolant modules for conducting coolant, and a coolant pump for pumping coolant through the coolant modules, with the coolant modules and the coolant pump being arranged along an arrangement direction. The distribution module extends from a first side to a second side in a coupling direction perpendicular to the arrangement direction. An evaporator and one condenser of a thermal management system are arrangeable on the first side on at least one of the coolant modules and a refrigerant line, and a compressor of the thermal management system is arrangeable on the first or second side on one or more of the coolant modules and another refrigerant line to form a refrigerant circuit. The coolant modules each have at least one valve and coolant interfaces connectable to one or more of the evaporator, the condenser, or coolant lines to form a coolant circuit.

### CROSS-REFERENCE TO RELATED APPLICATION

The present application is related and has right of priority to German Patent Application No. 10 2022 210 903.1 filed on Oct. 14, 2022 and is a nationalization of PCT/EP2023/074945 filed in the European Patent Office on Sep. 12, 2023, both of which are incorporated by reference in their entirety for all purposes.

### FIELD OF THE INVENTION

The invention relates generally to a distribution module, to a system including a heat pump having such a distribution module, and to a vehicle having such a system and/or such a distribution module.

### BACKGROUND

Electric vehicles require a cooling system in order to dissipate the power losses that arise in the units (battery, electric machine; reduction gear unit; bearings, etc.) and electronic components (inverters, DC/DC converters, DC-AC converters, etc.) during operation and during the charging of the battery.

The vehicles usually have multiple cooling circuits, which can be partly coupled to one another in order to form a thermal management system. In general, a coolant circuit having a water-glycol coolant is present, via which the heat loss is dissipated to the surroundings. A further circuit includes a heat pump/air-conditioning system for air conditioning the passenger compartment and/or for assisting in the dissipation of heat from the components. A third circuit is provided in many vehicles for dissipating heat from the lube oil-and cooling oil-system of a transmission in the vehicle.

In order to control the heat flows in an open loop, devices are required, which direct the fluid flows in different directions or assign the fluid flows to different circuits.

Magnetically actuated 2/3-way valves, or 2/4-way valves, or 3/4-way valves are typical, which valves are interconnected in different combinations in order to form the intended coolant circuits.

Rotary slide valves having stepper motor control are also known, which valves enable the interconnection of the circuits.

Electrical propulsion units require an intelligent distribution of energy in order to efficiently utilize the available battery capacity. A thermal management system is useful for this purpose, which system ensures that the energy is distributed in accordance with the requirements by supplying thermally managed coolant to the components according to demand in order to either heat or cool these components.

Multiple centrifugal pumps are usually arranged in the circuits in order to circulate the coolant. The circuits can be interconnected by the combination of individual valves or by a rotary valve system. Both require a correspondingly large amount of installation space and/or a great deal of installation effort to connect the wire harnesses. A heat pump is usually provided, which is integrated with the thermally coupled coolant circuits via water heat exchangers.

DE 10 2020 113 711 A1 describes a heat management module, which is used in an integrated heat management system for a vehicle. The heat management module includes first through fourth pumps and first through seventh valves for the closed-loop control of coolant flows and refrigerant flows.

### SUMMARY OF THE INVENTION

One problem addressed by the present invention is that of providing a distribution module for a thermal management system, a system, and a vehicle, which eliminate and/or at least improve one or more of the aforementioned disadvantages. In particular, one problem addressed by the present invention is that of providing a distribution module for a thermal management system, a system, and a vehicle, which reduces the effort required to install a heat pump and the various associated lines, permits quick installation, reduces an amount of installation space required for a heat pump, in particular in a vehicle, reduces a weight for the interface between the heat pump and the coolant circuits, reduces the effort required to inspect a heat pump, and/or increases a safety of the interface.

The problem is solved according to a first aspect by a distribution module for a thermal management system, including at least two coolant modules for conducting coolant, and a coolant pump for pumping coolant through the coolant modules, wherein the coolant modules and the coolant pump are arranged along an arrangement direction. The coolant modules and the coolant pump can have a minimum distance between each other along the arrangement direction of the distribution module. The distribution module also includes a plurality of refrigerant lines for conducting refrigerant. The plurality of refrigerant lines can be arranged on a first side on at least one of the coolant modules or between the coolant modules. The distribution module, in particular the coolant modules, extend(s) from the first side to a second side in a coupling direction extending perpendicularly to the arrangement direction. The distribution module is designed such that, on the first side, at least one evaporator and one condenser of the thermal management system, in particular of a heat pump of the thermal management system, are arrangeable on at least one of one the coolant modules and one of the refrigerant lines, and a compressor of the thermal management system, in particular of the heat pump, is arrangeable on the first side or on the second side on at least one of one of the coolant modules and one of the refrigerant lines. The refrigerant lines are connectable to the evaporator, the condenser, and the compressor for forming a refrigerant circuit. The coolant modules each have at least one valve and a plurality of coolant interfaces, which are connectable to coolant lines, to the evaporator, and to the condenser to form a coolant circuit.

The distribution module is therefore designed such that the coolant lines, in particular in a vehicle, are connectable to the coolant modules via the coolant interfaces. The coolant lines can conduct coolant from units in the vehicle, which are to be supplied with coolant, to the distribution module and/or from the distribution module to the units. The coolant modules are still connectable to the condenser and to the evaporator by the coolant interfaces in order to easily form the coolant circuit. In addition, the refrigerant circuit can be easily established by arranging the condenser, the evaporator, and the compressor on the distribution module, in particular on the coolant modules. To this end, the evaporator, the condenser, and the compressor can be connected on the first or the second side to the provided refrigerant lines. The refrigerant lines can be pressure-resistant. The refrigerant lines can be made of a metal and/or a mixture of substances including at least one metal, so that the refrigerant lines have a longer service life in comparison to flexible lines. The coolant circuit can be connected and/or controlled in a closed loop by the provided valves. Due to the arrangement of the evaporator as a heat exchanger and of the condenser as a further heat exchanger of the thermal management system, in particular of the heat pump, on the first side of the coolant modules, a thermal energy exchange can take place between the refrigerant and the coolant.

It is particularly advantageous that the refrigerant lines can be relatively short, since the evaporator, the condenser, and the compressor are arranged on the first side or the compressor is arranged on the second side. Due to the spatial proximity and the compact design of the distribution module, less refrigerant is needed, which refrigerant is conducted in the refrigerant lines. The shorter refrigerant lines also lead to a reduction in the weight of the distribution module due to the lower weight of the refrigerant lines and the lower filling capacity.

The distribution module can include two, three or more coolant modules, in particular, however, three coolant modules.

The thermal management system can include or be the heat pump. The thermal management system can be a thermal management system of a vehicle.

The coolant pump can include a plurality of coolant pump interfaces which are designed such that the coolant pump is connectable to a coolant circuit.

The distribution module can include coolant module housings which accommodate the coolant modules. The plurality of coolant interfaces can protrude through the coolant module housing in order to enable coolant lines to be connected to the coolant interfaces.

The coolant interfaces can be designed such that coolant can flow, in particular be pumped, into and out of the coolant module through the coolant interfaces of the coolant module. The coolant flow through the coolant module can be controlled in an open loop using the valve.

The plurality of coolant interfaces can include a plurality of internal coolant interfaces and a plurality of external coolant interfaces. The plurality of external coolant interfaces is connectable to coolant lines which conduct, in particular, coolant to and from units and/or components in the vehicle, such as a prime mover and a passenger compartment heat exchanger. The plurality of internal coolant interfaces provide a coolant connection and/or a coolant interface between the coolant modules, in particular the axial slide valves of the coolant modules, in order to enable, in particular, the necessary functions and/or interconnections. Depending on the application and/or need, the plurality of internal and/or external coolant interfaces can be connectable to pipes and/or hoses, dead-ended, closed, and/or can be omitted.

The coolant pump can pump two, three or more coolant circuits. The coolant pump can include one, two, three or more coolant pump(s), which are, in particular, for pumping the two, three or more coolant circuits. The coolant pump can include one or more electric drive motor(s).

The coolant modules and/or the coolant pump can be arranged along the arrangement direction such that they are arranged one after the other, in particular having a similar to identical spatial orientation.

A minimum distance can be present between the individual coolant modules and/or the coolant pump. The coolant modules and/or the coolant pump can have a predetermined outer diameter along the arrangement direction, which, in particular, is greater than the minimum distance. The minimum distance can be determined on the basis of at least one of the outer diameter, an empty weight, an operating weight, and a height along an extension direction of the coolant modules and/or coolant pump and the refrigerant lines. The empty weight can be a weight of the coolant modules when these have no coolant. The operating weight can be a weight of the coolant modules when these are at least partially, in particular completely, filled with coolant. The extension direction is perpendicular to the arrangement direction and the coupling direction. If the refrigerant lines are arranged on the first side, the minimum distance can be smaller in comparison to the minimum distance when the refrigerant lines are arranged between the coolant modules, in order to further reduce a required installation space.

The minimum distance can be 3 mm to 95 mm, in particular 5 mm to 25 mm. Alternatively, or additionally, the minimum distance between the coolant modules, in particular two adjacent coolant modules, and/or the coolant pump, can be identical or different. For example, a first predetermined minimum distance can be present between two adjacent coolant modules and a second predetermined minimum distance can be present between one of the coolant modules and the coolant pump, which first and second minimum distances are different from one another. Alternatively, or additionally, the minimum distance between the individual coolant modules can be different and, in particular, lie in the aforementioned ranges. The minimum distance can be selected such that the coolant modules and/or the coolant pumps at least partially adjoin each other. Therefore, outer surfaces of the coolant modules and/or of the coolant pump can at least partially adjoin each other and/or be in contact with each other.

The refrigerant lines and/or the coolant interfaces can be cylindrical. The refrigerant lines and/or the coolant interfaces can be designed such that the evaporator, the condenser, the compressor, or the coolant lines, can be flanged.

The distribution module, in particular the coolant modules or a support plate of the distribution module, can have connection interfaces, which are designed such that the evaporator, the condenser, and/or the compressor are removably arrangeable on the connection interfaces.

The coolant modules can control, in an open loop, at least one coolant flow through the plurality of coolant interfaces on the basis of a valve position of the valve.

At least one of the valves can be a slide valve, in particular an axial slide valve. Axial slide valves offer the advantage as compared to rotary slide valves that the axial slide valves can control, in an open loop, switching states of the coolant interfaces regardless of the position of the valve, in comparison to the rotary slide valves, and thus offer greater flexibility.

The plurality of coolant interfaces of at least one of the coolant modules can include two, three, four, five or more coolant interfaces. In particular, the plurality of coolant interfaces of at least one of the coolant modules can be four or five. The coolant modules can have a different and/or identical plurality of coolant interfaces. A first coolant module of the coolant modules can include four coolant interfaces and a second coolant module of the coolant modules can include five coolant interfaces. If the distribution module includes three coolant modules, a first coolant module of the coolant modules can include five coolant interfaces, a second coolant module of the coolant modules can include four coolant interfaces, and a third coolant module of the coolant modules can include five coolant interfaces as viewed along the arrangement direction.

The coolant modules and/or the refrigerant pump can be cylindrical, extend along the extension direction, and have a cylinder base which is perpendicular to the extension direction. The cylinder base can be parallel to a plane which extends through the arrangement direction and the coupling direction. The coolant modules can have a module length along the coupling direction. The module length can correspond to an outer diameter along the coupling direction.

The refrigerant lines arranged between the coolant modules can conduct refrigerant from the first side to the second side and/or from the second side to the first side, the refrigerant lines arranged between the coolant modules extending, in particular, substantially along the coupling direction. This arrangement of the refrigerant lines is advantageous, in particular, when the compressor is arranged on the second side. It is therefore possible to provide a refrigerant line which is as short as possible from the compressor on the second side to the evaporator and to the condenser on the first side.

The refrigerant lines arranged between the coolant modules can have a predetermined line width along the arrangement direction, which line width is less than or equal to, or less than the minimum distance between the coolant modules. When the coolant modules are cylindrical, the predetermined module width can correspond to the outer diameter of the coolant modules.

At least the coolant modules, the plurality of coolant interfaces, and/or the refrigerant lines can be formed in one piece.

The coolant modules, which are spaced apart from each other by the minimum distance, and/or the coolant pump can be connected by a connecting wall which extends substantially along the arrangement direction and the extension direction. The connecting wall can have a wall length (wall thickness) which extends along the coupling direction. The wall length can be smaller than the module length of the coolant modules and/or a pump length of the coolant pump, the module length and the pump length extending along the coupling direction. The pump length can correspond to an outer diameter of the coolant pump along the coupling direction. When the coolant pump and/or the coolant modules are cylindrical, the pump length, or the module length, can correspond to the outer diameter. An amount of material required for connecting the coolant modules and/or the coolant pump can therefore be reduced.

The coolant modules can have the module length which extends along the coupling direction, wherein the refrigerant lines arranged between the coolant modules have a predetermined line length which extends along the coupling direction, which line length is equal to, greater than or equal or, or greater than the module length. In particular, the line length can be selected such that, when the refrigerant lines are arranged between the coolant modules, the refrigerant lines protrude on the first side and/or the second side. The refrigerant lines can have the line width, which, in particular, is smaller than the line length.

The coolant modules can extend from a lower end portion to an upper end portion along the extension direction. A valve actuation mechanism of the valve is formed in the upper end portion and/or forms the upper end portion. The valve actuation mechanism can include actuators, which actuators can be, in particular, electrical and/or magnetic actuators.

At least one of the valves having a valve actuation mechanism can include a closing cover, which accommodates the valve actuation mechanism. The closing cover has a length along the arrangement direction and/or a width along the coupling direction which corresponds to the module length and/or the module width. When the coolant modules are cylindrical, the closing cover can be cylindrical. The outer diameter of the coolant modules can be greater or equal to, or greater than an outer diameter of the closing cover.

The distribution module can include a support plate having a top side and an underside, which is positioned opposite the top side and extends substantially within a plane arranged perpendicularly to the extension direction. The top side and the underside can be parallel to a plane which extends through the arrangement direction and the coupling direction. The lower end portions of the coolant modules can be arranged on the top side of the support plate, in particular such that the valve actuation mechanisms are accessible from the opposite side. The support plate, in particular, supports at least one of the evaporator, the condenser, and the compressor when the evaporator, condenser, and compressor are arranged on the distribution module. The support plate can be designed, in particular, such that the distribution module, in particular coolant module housings of the distribution module described in the following and/or a pump housing described in the following, are formed in one piece with the support plate. Therefore, the coolant modules and/or the coolant pump are integratable into the support plate 170, which is formed in one piece. The support plate can decouple vibrations. When the distribution module is mounted in a vehicle, the vibrations can be generated by the vehicle, for example, by a drive in the vehicle. The support plate can provide noise, vibration, and harshness, or NVH, measures. To this end, the support plate can have an elastic layer at least on the underside, which elastic layer damps vibrations. The elastic layer can at least partially, in particular completely, cover the underside.

The support plate can have a bearing surface on the top side. The bearing surface can be arranged, with respect to the coolant modules, on the first and/or the second side(s) on the top side of the support plate. The bearing surface can at least partially replicate an outer contour of the compressor in order to support the compressor when it is arranged on the distribution module. The bearing surface can support the compressor.

At least one of the coolant modules can include coolant interfaces of the plurality of coolant interfaces on the first and/or the second side(s), which coolant interfaces on the first and/or the second side(s) along the extension direction have at least one predetermined distance between two adjacent coolant points of the coolant interfaces. Two adjacent coolant interfaces of a coolant module on the first and/or the second side(s) can have a first predetermined distance with respect to one another along the extension direction. Alternatively, or additionally, two adjacent coolant interfaces can have a second predetermined distance with respect to one another along the extension direction. For example, in a coolant module including four coolant interfaces, as viewed from the upper end portion to the lower end portion, first the upper two adjacent coolant interfaces can be arranged such that they have the first distance therebetween. In the direction of the lower end portion, the third coolant interface can be spaced apart from the second coolant interface by the second distance. The third coolant interface can be spaced apart from the fourth coolant interface by the first distance.

If the valve is in the form of a slide valve, the coolant interfaces can be particularly advantageously controlled in an open loop, opened, and/or closed. Furthermore, due to the various arrangements of the coolant interfaces, a connection can be provided on various formed coolant lines and/or a corresponding guidance of the coolant lines.

Correspondingly, a row of coolant interfaces along the extension direction can be formed on at least one of the coolant modules. In particular, first coolant interfaces of the plurality of coolant interfaces, which are connectable to the evaporator and the condenser, can be arranged on the first side. Second coolant interfaces of the plurality of coolant interfaces can be arranged on the second side, which coolant interfaces are connectable to coolant lines, in particular in the vehicle. Correspondingly, the connections for the coolant circuit can be made possible in a particularly simple manner.

Not all coolant interfaces must be connected to coolant lines in order to enable operation of the distribution module. Predetermined coolant interfaces which are not connected or not used can remain closed by the valve.

The plurality of coolant interfaces can allow for a plurality of coolant circuits. If there are two coolant interfaces on the first side of a coolant module, one single coolant circuit can be made possible. If there are four coolant interfaces, two coolant interfaces in each case can be associated with one coolant circuit, so that two coolant circuits are made possible.

The distribution module can also include a pump housing have a removable pump housing cover, which pump housing accommodates the coolant pump. The pump housing can be located before or after the coolant modules or coolant housings along the arrangement direction. Additionally, or alternatively, the distribution module can include a compressor housing having a removable compressor housing cover, which compressor housing accommodates the compressor and is arranged, in particular, on the first side on at least one of the coolant modules. The pump housing, the coolant housing, and/or the compressor housing can be formed in one piece. The pump housing cover, the compressor housing cover, and/or the closing cover can be formed in one piece.

The distribution module can also include at least one additional module having a coolant reservoir, a dryer, a refrigerant reservoir, and/or an oil separator, which is coupleable to the refrigerant circuit, the at least one additional module being arranged, in particular, before or after the coolant modules along the arrangement direction. Advantageously, the additional module is arranged on the opposite side of the coolant pump as viewed along the arrangement direction. The distribution module can include an additional module housing, which accommodates the additional module.

The distribution module can be designed such that the evaporator and the condenser are arrangeable along the arrangement direction one after the other along the extension direction, and/or are arrangeable in a stackable manner along the extension direction. In the stackable arrangement, the distribution module can be designed such that a predetermined distance is formed between the evaporator and the condenser. The predetermined distance can be determined on the basis of a line length of the refrigerant lines between the evaporator and the condenser.

The distribution module can also be arrangeable in a vehicle. In particular, the distribution module can be suspendable, for example, in an engine compartment of the vehicle.

The distribution module can also include an expansion valve, which regulates the pressure of a or the refrigerant circuit through the evaporator, the condenser, and the compressor. Alternatively, or additionally, the distribution module can be designed such that the expansion valve is arrangeable on the distribution module. The expansion valve can be arrangeable or arranged such that, once arranged, the expansion valve is located between the evaporator and the condenser. The expansion valve can be pressure-resistant and, in particular, is designed such that the parameters of the expansion valve are changeable. This can be carried out preferably by electrical activation.

The coolant modules, the coolant pump, the pump housing, the compressor housing, and/or the additional module can have a maximum height along the extension direction, in particular such that the maximum height corresponds to a height of the condenser and/or the evaporator, which are arrangeable next to one another, or to an overall height of the stackable condenser and evaporator.

The distribution module can also include a control unit, which is for the open-loop control of at least one of the coolant pump, at least one of the valves of the coolant modules, the expansion valve, the compressor, the evaporator, the condenser, and the additional module, which control unit is arranged, in particular, in the pump housing.

The coolant pump can be arranged before, after, or between the coolant modules along the arrangement direction.

The plurality of refrigerant lines can include high-pressure lines and low-pressure lines, which high-pressure lines conduct a refrigerant flow from the compressor to the condenser, in particular to the expansion valve (or expansion throttle), and which low-pressure lines conduct a refrigerant flow, in particular from the expansion valve (or expansion throttle) to the evaporator and to the compressor. The high-pressure lines can conduct the refrigerant, or the refrigerant flow, at high pressure, relative to the low-pressure lines, and the low-pressure lines can conduct the refrigerant, or the refrigerant flow, at low pressure, relative to the high-pressure lines. At least one of the low-pressure lines can establish a refrigerant connection between the evaporator and the compressor. At least one of the high-pressure lines can establish a refrigerant connection between the compressor and the condenser. Alternatively, or additionally, one single high-pressure line can conduct a refrigerant flow from the compressor to the condenser, in particular to the expansion valve, one single low-pressure line can conduct a refrigerant flow, in particular from the expansion valve to the evaporator and to the compressor, and a refrigerant line can conduct a refrigerant flow from the evaporator to the condenser.

The problem is solved according to a second aspect by a system including a heat pump having at least one of an evaporator, a condenser, and a compressor, and by a distribution module according to the first aspect, which heat pump is arranged on the distribution module. The system can include or be a thermal management system, which thermal management system includes or is the heat pump.

The compressor of the heat pump can be electrically operable, and operable with high voltage of more than 350 V, in particular of more than 600 V.

The refrigerant can be or include a natural refrigerant, in particular propane (R-290), propene (R-1270), carbon dioxide (R-744), or butane (R-600, R-600a).

With respect to the distribution module according the first aspect, described features can be features of the system according to the second aspect.

The problem is also solved by a third aspect by a vehicle including a distribution module according to the first aspect and/or a heat pump according to the second aspect.

### BRIEF DESCRIPTION OF THE DRAWINGS

Preferred exemplary embodiments are explained by way of example on the basis of the accompanying figures. Wherein:

FIG. 1 shows a first exemplary embodiment of a distribution module including a heat pump;

FIGS. 2 and 3 show a second exemplary embodiment of a distribution module including a heat pump;

FIGS. 4 and 5 show a third exemplary embodiment of a distribution module including a heat pump; and

FIG. 6 shows a vehicle including a distribution module and a heat pump.

### DETAILED DESCRIPTION

Reference will now be made to embodiments of the invention, one or more examples of which are shown in the drawings. Each embodiment is provided by way of explanation of the invention, and not as a limitation of the invention. For example, features illustrated or described as part of one embodiment can be combined with another embodiment to yield still another embodiment. It is intended that the present invention include these and other modifications and variations to the embodiments described herein.

In the figures, identical or substantially functionally identical or functionally similar elements are labeled with identical reference characters.

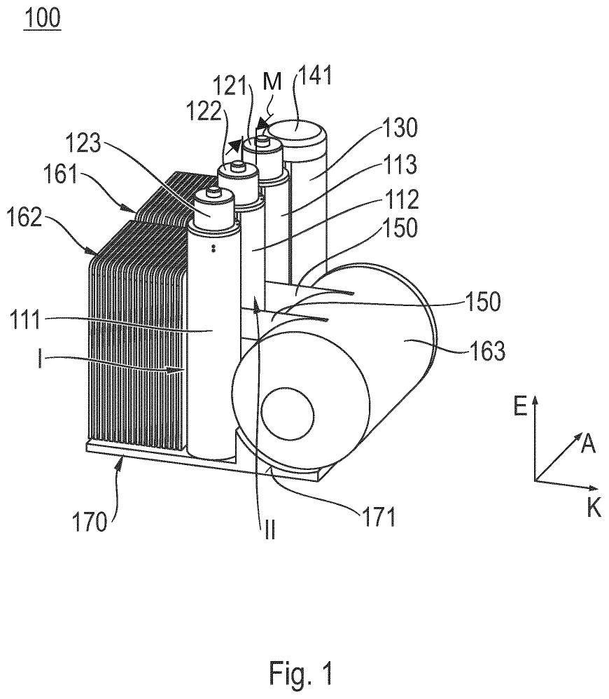

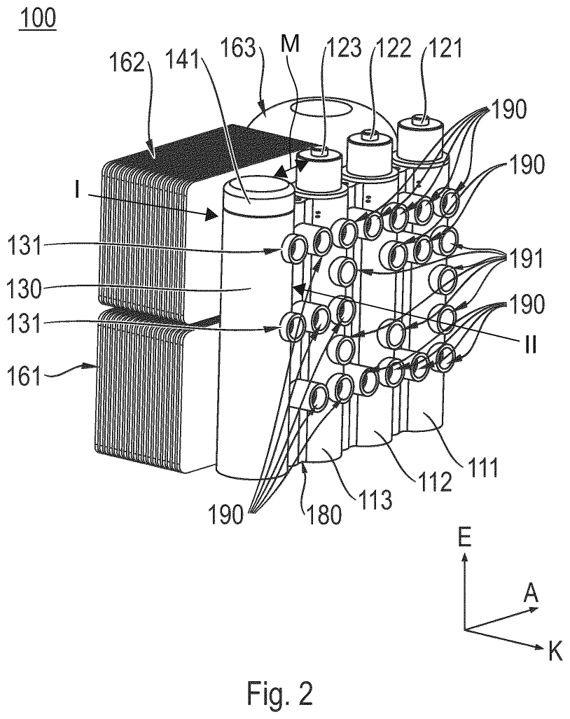

FIG. 1 shows a first exemplary embodiment of a distribution module 100 including three coolant modules 111, 112, 113 and a coolant pump 130, which are connected by connecting walls 180 (see FIG. 2). The coolant modules 111, 112, 113 and the coolant pump 130 are arranged along an arrangement direction A. The coolant modules 111, 112, 113 and the coolant pump 130 have a minimum distance M between two adjacent units 111, 112, 113 along the arrangement direction A. The coolant modules 111, 112, 113 and the coolant pump 130 are cylindrical and have a cylinder base and a cylinder height. The cylinder base is parallel to a plane which is formed through the arrangement direction A and a coupling direction K, which extends perpendicularly to the arrangement direction A. The cylinder height extends along an extension direction E, which is perpendicular to the cylinder base.

The distribution module 100 also has a support plate 170 having a top side and an underside, which is opposite the top side. Both the top side and the underside are also parallel to the aforementioned plane which extends through the arrangement direction A and the coupling direction K. The coolant modules 111, 112, 113 have a lower end portion and an upper end portion, which lower end portion is arranged on the top side of the support plate 170. The upper end portion of each coolant module 111, 112, 113 is formed by a closing cover 121, 122, 123, a valve actuation mechanism for a valve of the respective coolant module 111, 112, 113 being accommodated in the respective closing cover 121, 122, 123. The valves are slide valves, in particular axial slide valves. The coolant pump 130 is arranged having a lower end portion thereof on the support plate 170. An upper end portion, which is positioned opposite the lower end portion, is formed by a pump cover 141, which has substantially the same radius as the coolant pump 130. The support plate 170 can be designed, in particular, such that the distribution module 100, in particular coolant module housings of the distribution module 100 described in the following, and/or a pump housing described in the following, is formed in one piece with the support plate 170. Therefore, the coolant modules 111, 112, 113 and/or the coolant pump 130 are integratable into the support plate 170, which is formed in one piece.

The distribution module 100, in particular the coolant modules 111, 112, 113, have a first side I and an opposite second side II, with the distribution module 100, or the coolant modules 111, 112, 113, extending from the first side I to the second side Il along the coupling direction K.

According to FIG. 1, the distribution module 100 is designed such that an evaporator 161 and a condenser 162 of a heat pump are arrangeable on the distribution module 100, in particular on the coolant modules 111, 112, 113, on the first side I. The distribution module 100 is designed such that the evaporator 161 and the condenser 162 are arrangeable one after the other along the arrangement direction A. The distribution module 100 is designed such that the evaporator 161 and the condenser 162 are arrangeable on the distribution module 100 at a shortest distance along the coupling direction. In particular, the evaporator 161 and the condenser 162 are arrangeable at least partially adjacent to the coolant modules 111, 112, 113. The support plate 170 supports the evaporator 161 and the condenser 162. The distribution module 100 is designed such that the distance between the evaporator 161 and the condenser 162 is determined on the basis of a line length of at least one refrigerant line 150 of the distribution module, which refrigerant line(s) 150 connects the evaporator 161 and the condenser 162 to each other.

The distribution module 100 is also designed such that a compressor 163 is arrangeable on the second side I of the distribution module 100. According to FIG. 1, the distribution module 100 has at least two refrigerant lines 150, which extend from the second side II to the first side I and establish a refrigerant connection between the condenser 162, the evaporator 161, and the compressor 163. For this purpose, the refrigerant lines 150 are connectable to the condenser 162, the evaporator 161, and the compressor 163. For example, the refrigerant lines 150 can be designed such that the condenser 162, the evaporator 161, and/or the compressor 163 may be flanged The refrigerant lines 150 extend, according to FIG. 1, substantially along the coupling direction K and are cylindrical, such that a base of the cylinder is located within a plane extending through the extension direction E and the arrangement direction A. Therefore, the refrigerant lines 150 are a shortest connection between the compressor 163, which is arranged on the second side II, and the evaporator 161 and the condenser 162 arranged on the first side I.

One of the refrigerant lines 150 connects the compressor 163 to the condenser 162 and is forms a high-pressure line. Another one of the refrigerant lines 150 connects the evaporator 161 to the compressor 163 and forms a low-pressure line. The compressor 163 compresses the refrigerant, and the compressed refrigerant is conducted to the condenser 162 via the high-pressure line, so that the condenser gives off thermal energy to the coolant here. Due to the compression of the refrigerant, a temperature and a pressure of the refrigerant are increased. Therefore, this high-pressure line conducts refrigerant at a high pressure. Using the evaporator 161, thermal energy is transmitted from the coolant to the refrigerant and is subsequently conducted to the compressor 163 via the low-pressure line. In comparison to the high-pressure line, the low-pressure line conducts the refrigerant at a comparatively low pressure.

The high-pressure and low-pressure lines 150 extend, according to FIG. 1, substantially parallel to the coupling direction K and are therefore a shortest connection between the first side I and the second side II.

The support plate 170 has a bearing surface 171 on the top side, which is proximate to the second side II. The bearing surface 171 supports the compressor 163. For this purpose, the bearing surface at least partially replicates an outer contour of the compressor 163.

The minimum distance M corresponds, according to FIG. 1, an outer diameter of the refrigerant lines 150, so that the refrigerant lines are arranged between the coolant modules 111, 112, 113 but the installation space required along the arrangement direction A is kept to a minimum.

A distribution module 100 for a heat pump is therefore provided, which has at least one evaporator 161, one condenser 162, and one compressor 163, the units of the heat pump being easily arrangeable on the distribution module 100. In addition, a necessary installation space is kept to a minimum and the necessary refrigerant lines 150 are already present and merely need to be connected.

Each of the coolant modules 111, 112, 113 includes a plurality of coolant interfaces 190, 191 (see e.g., FIG. 2), which coolant interfaces 190, 191 are connectable to coolant lines, for example, in a vehicle. Therefore, a simplified modular interface is provided for the arrangement of the heat pump and for the thermal energy exchange between the refrigerant and the coolant.

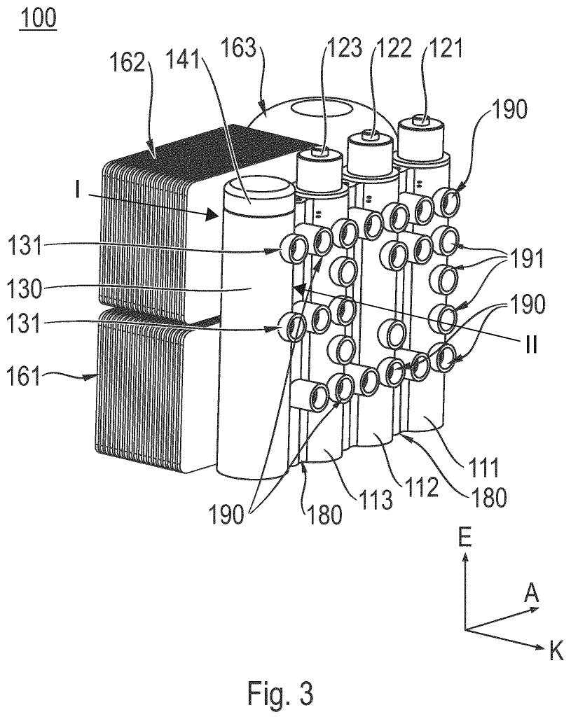

FIGS. 2 and 3 show a second exemplary embodiment of a distribution module 100, wherein, in comparison to the first exemplary embodiment, the compressor 163 is also arrangeable on the first side I. FIG. 3 shows the second exemplary embodiment of the distribution module 100 shown in FIG. 2 with fewer reference characters for the sake of greater clarity. The evaporator 161 and the condenser 162 are arrangeable on the distribution module 100 one after the other along the extension direction E or stacked. Accordingly, the refrigerant lines 150 are not shown in FIG. 2 and are arranged on the first side I.

The similarity between the exemplary embodiments shown in FIGS. 1-5 is that the evaporator 161 and the condenser 162 are arrangeable on the distribution module 100 such that a distance to the compressor 163 is kept as small as possible in order to make short refrigerant lines 150 possible. This can be achieved by virtue of the fact that the evaporator 161, the condenser 162, and/or the compressor 163 are arrangeable adjacent to the coolant modules 111, 112, 113. Alternatively, or additionally, the evaporator 161, the condenser 162, and/or the compressor 163 are connectable to and arrangeable at the refrigerant lines 150.

According to FIGS. 2 and 3, the distribution module 100 includes internal coolant interfaces 190 and external coolant interfaces 191, which external coolant interfaces 191, in comparison to the internal coolant interfaces 190, are transparent. The external coolant interfaces are connectable to coolant lines which conduct coolant to and from units and/or components in the vehicle, such as a motor and a passenger compartment heat exchanger. The internal coolant interfaces 190 provide a coolant connection and/or a coolant interface between the coolant modules 111, 112, 113, in particular the axial slide valves of the coolant modules 111, 112, 113, in order to enable the necessary functions and/or interconnections. Depending on the application and/or need, the internal coolant interfaces can be connectable to pipes and/or hoses, dead-ended, closed, and/or can be omitted.

FIGS. 2 and 3 also show coolant pump interfaces 131 of the coolant pump 130, which are connectable to the coolant circuit of the coolant modules 111, 112, 113 in order to pump coolant through the coolant modules 111, 112, 113 and the coolant lines. A number of coolant pump interfaces 131 can be provided which corresponds to a number of coolant circuits.

FIGS. 2 and 3 show that the coolant modules 111, 113 each include five coolant interfaces 190, 191, in particular two internal coolant interfaces 190 and three external coolant interfaces 191, and the coolant module 112 includes four coolant interfaces 190, 191, in particular three internal coolant interfaces 190 and one external coolant interface 191. The coolant interfaces 190, 191 of the coolant modules 111, 113 are arranged on the respective coolant module 111, 113 at a predetermined distance along the extension direction E. The coolant interfaces 190 are connectable to coolant lines, for example, in the vehicle. The coolant interfaces 190, 191 are cylindrical and have a cylinder base, which extends parallel to a plane which extends through the extension direction E and the arrangement direction A. The coolant interfaces 190, 191 are arranged along the arrangement direction A such that a straight connecting line is formed through the centers of the cylinder bases of the coolant interfaces of each coolant module 111, 112, 113 parallel to the axis of extension E.

Therefore, the coolant circuit can be advantageously established on the second side II by connecting the coolant lines to the coolant interfaces 190, 191 of the distribution module 100. The heat exchangers (evaporator 162 and condenser 161) and the compressor 163 of the heat pump can be arranged in a space-saving manner on the first side I. Due to the modular design, lines for the coolant circuits and the refrigerant circuits can be kept as short as possible. In addition, the distribution module 100 can be validated in advance, so that an installation and further validation carried out during assembly with the heat pump and the coolant lines can also be shortened.

FIGS. 2 and 3 show the connecting wall 180, which connects the coolant modules 111, 112, 113 and the coolant pump 130 to each other. The connecting wall 180 is interrupted in sections by the internal coolant interfaces 190. The coolant modules 111, 112, 113, the coolant pump 130, the connecting wall 180, the coolant interfaces 190, and/or the external coolant interfaces 191 can be formed in one piece.

The coolant modules 111, 112, 113 and/or the coolant pump 130 can include the coolant module housing, or the pump housing, wherein these can also be formed in one piece.

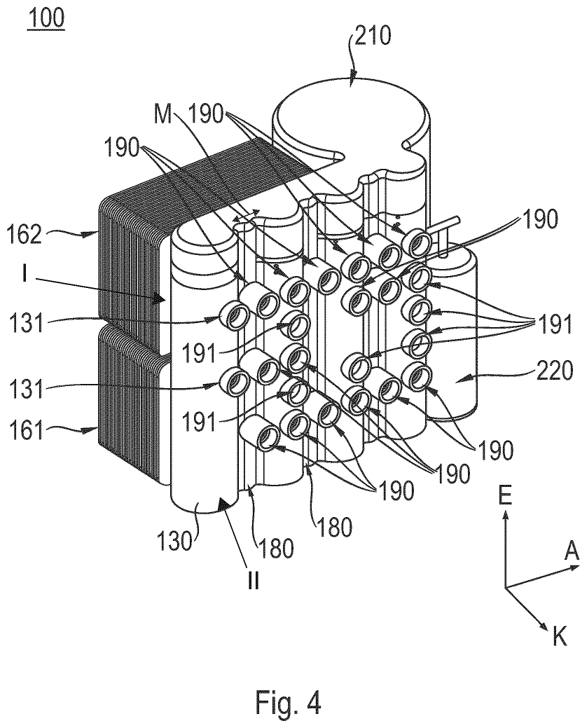

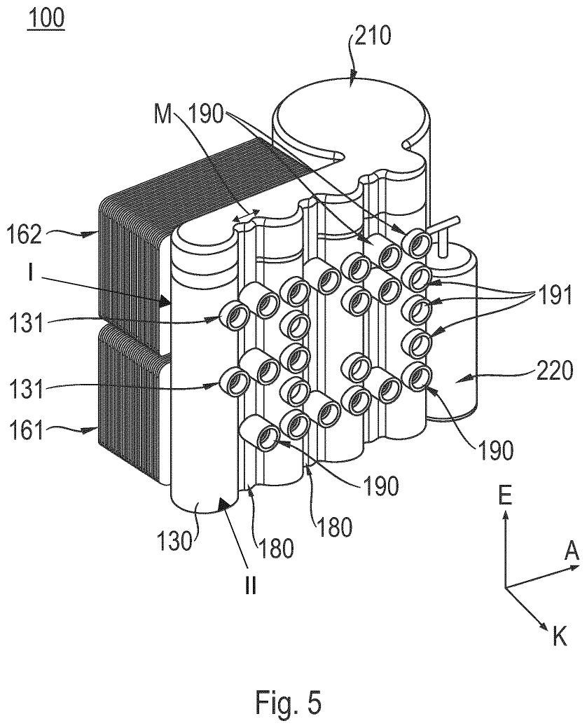

FIGS. 4 and 5 show another exemplary embodiment of a distribution module 100, wherein, in comparison to the exemplary embodiment shown in FIG. 2, the distribution module in FIG. 4 shows the pump housing and an additional module housing. FIG. 5 shows the further exemplary embodiment of the distribution module 100 shown in FIG. 4 with fewer reference characters for the sake of greater clarity.

The pump housing accommodates the coolant pump 130. The coolant pump 130 can include, regardless of the exemplary embodiment shown, two or more coolant pumps for pumping coolant, one coolant pump in particular being assignable to one coolant circuit.

FIGS. 4 and 5 also show that the pump housing and the coolant modules 111, 112, 113 are covered by corresponding covers, including the pump housing cover 210, the covers for the coolant modules 111, 112, 113 and the pump housing 210 being formed in one piece.

The additional module housing includes an additional module 220, which additional module 220 includes one of a dryer, a refrigerant reservoir, a reheater, or an oil separator, and is coupleable to the refrigerant circuit. According to FIGS. 3 and 4, the additional module, or the additional module housing, is also arranged along the arrangement direction A downstream from the coolant modules 111, 112, 113 and on the opposite side of the coolant pump 130. The additional module 220, or the additional module housing, can be arranged on, and/or connected to, the coolant module 111 by one of the connecting walls 180.

The distribution modules 100 shown in FIGS. 1-5 can also include a control unit, for example, in the pump housing, for the open-loop control of the individual elements of the distributor 100 and/or of the heat pump.

The minimum distance M is selected such that the minimum distance is greater than or equal to, or greater than an outer diameter of the refrigerant lines 150. If no refrigerant lines 150 extend between two coolant modules 111, 112, 113 from the first side I to the second side II, the minimum distance M can be smaller. In particular, the minimum distance M can be selected such that outer surfaces, in particular lateral surfaces of the coolant modules 111, 112, 113, can at least partially adjoin one another in order to provide a structure which is as compact as possible.

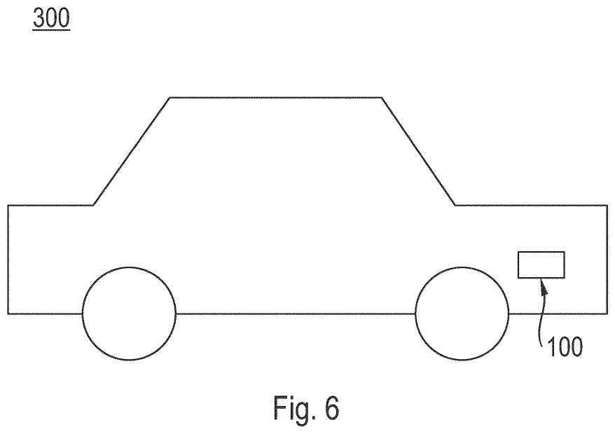

FIG. 6 shows a vehicle 300 including a distribution module 100, wherein a heat pump and coolant lines in the vehicle 300 are connected to and/or arranged at the distribution module 100.

Modifications and variations can be made to the embodiments illustrated or described herein without departing from the scope and spirit of the invention as set forth in the appended claims. In the claims, reference characters corresponding to elements recited in the detailed description and the drawings may be recited. Such reference characters are enclosed within parentheses and are provided as an aid for reference to example embodiments described in the detailed description and the drawings. Such reference characters are provided for convenience only and have no effect on the scope of the claims. In particular, such reference characters are not intended to limit the claims to the particular example embodiments described in the detailed description and the drawings.

### REFERENCE CHARACTERS

100 distribution module
111, 112,113 coolant module
121, 122, 123 closing cover
130 coolant pump
131 coolant pump interface
141 pump cover
150 refrigerant line
161 evaporator
162 condenser
163 compressor
170 support plate
171 bearing surface
180 connecting wall
190 internal coolant interfaces
191 external coolant interfaces
210 single-piece cover
220 additional module housing
300 vehicle
M minimum distance
I first side
II second side

1.-17. (canceled)

18. A distribution module (100) for a thermal management system, comprising:
at least two coolant modules (111, 112, 113) for conducting coolant;
a coolant pump (130) for pumping coolant through the at least two coolant modules (111, 112, 113), the at least two coolant modules (111, 112, 113) and the coolant pump (130) being arranged along an arrangement direction (A) of the distribution module (100);
a plurality of refrigerant lines (150) for conducting refrigerant,
wherein the distribution module (100) extends from a first side (I) to a second side (II) in a coupling direction (K) perpendicular to the arrangement direction (A), at least one evaporator (161) and one condenser (162) of a thermal management system being arrangeable on the first side (I) on at least one of the at least two coolant modules (111, 112, 115) and one of the plurality of refrigerant lines (150), and a compressor (163) of the thermal management system being arrangeable on the first side (I) or on the second side (II) on one or more of the at least two coolant modules (111, 112, 113) and another of the plurality of refrigerant lines (150) to form a refrigerant circuit,
wherein the at least two coolant modules (111, 112, 113) each have at least one valve and a plurality of coolant interfaces (190, 191) connectable to one or more of the at least one evaporator (161), the condenser (162), or coolant lines to form a coolant circuit.

19. The distribution module (100) of claim 18, wherein one or more of the coolant pump (130) or the at least two coolant modules (111, 112, 113) is cylindrical, extends along an extension direction (E), and has a cylinder base formed perpendicularly to the extension direction (E), the extension direction (E) being perpendicular to the arrangement direction (A) and the coupling direction (K).

20. The distribution module (100) of claim 18,
wherein the plurality of refrigerant lines (150) extend on the first side (I) on at least one of the at least two coolant modules (111, 112, 113); or
wherein the plurality of refrigerant lines (150) extend between the at least two coolant modules (111, 112, 113) for conducting refrigerant between the first side (I) and the second side (II) and extend substantially along the coupling direction (K).

21. The distribution module (100) of claim 18, wherein the plurality of refrigerant lines (150) extend between the at least two coolant modules (111, 112, 113), each of the plurality of refrigerant lines (150) having an outer diameter less than or equal to a minimum distance (M) along the arrangement direction (A), the minimum distance (M) being defined between adjacent ones of the at least two coolant modules (111, 112, 113) or between one of the at least two coolant modules (111, 112, 113) and the coolant pump (130).

22. The distribution module (100) of claim 18,
wherein each of the at least two coolant modules (111, 112, 113) has a predetermined module length along the coupling direction (K),
wherein each of the plurality of refrigerant lines (150) extends between the at least two coolant modules (111, 112, 113) and has a predetermined line length along the coupling direction (K), the predetermined line length being greater than or equal to the predetermined module length.

23. The distribution module (100) of claim 18,
wherein the at least two coolant modules (111, 112, 113) extend from a lower end portion to an upper end portion along an extension direction, the extension direction (E) being perpendicular to the arrangement direction (A) and the coupling direction (K),
wherein a valve actuation mechanism (121, 122, 123) of a particular valve of the at least one valve is at least one of: in the upper end portion or defines the upper end portion.

24. The distribution module (100) of claim 23, further comprising:
a support plate (170) having a top side and an underside, the underside being positioned opposite the top side and extending substantially within a plane arranged perpendicularly to the extension direction (E),
wherein the lower end portion of each of the at least two coolant modules (111, 112, 113) is arranged on the top side of the support plate (170), wherein the support plate (170) is configured to support at least one of the at least one evaporator (161), the condenser (162), or the compressor (163) when arranged on the distribution module (100).

25. The distribution module (100) of claim 24,
wherein the support plate (170) comprises a bearing surface (171) for supporting the compressor (163), the bearing surface (171) at least partially replicating an outer contour of the compressor (163).

26. The distribution module (100) of claim 18,
wherein at least one of the at least two coolant modules (111, 112, 113) comprises coolant interfaces (190, 191) of the plurality of coolant interfaces (190, 191) on one or both of the first side (I) or the second side (II),
wherein a predetermined distance is defined along an extension direction (E) between two adjacent coolant interfaces of the coolant interfaces (190, 191), the extension direction (E) being perpendicular to the arrangement direction (A) and the coupling direction (K).

27. The distribution module (100) of claim 18, further comprising at least one of:
a pump housing comprising a removable pump housing cover, the pump housing being configured to accommodate the coolant pump (130); or
a compressor housing comprising a removable compressor housing cover, the compressor housing being configured to accommodate the compressor (163), the compressor housing being on the first side (I) on at least one of the at least two coolant modules (111, 112, 113).

28. The distribution module (100) of claim 27, further comprising:
at least one additional module (220) comprising one of a dryer, a refrigerant reservoir, or an oil separator,
wherein the at least one additional module (220) is arranged along the arrangement direction before or after the at least two coolant modules.

29. The distribution module (100) of claim 28,
wherein one or more of the at least two coolant modules (111, 112, 113), the coolant pump (130), the pump housing, the compressor housing, or the at least one additional module (220) have a maximum height along an extension direction, the maximum height corresponding to a height of the condenser (162) and the at least one evaporator (161) stacked in the extension direction (E), the extension direction (E) being perpendicular to the arrangement direction (A) and the coupling direction (K).

30. The distribution module (100) of claim 28, further comprising:
a control unit for open-loop control of at least one of the coolant pump (130), one or more of the at least one valve of the at least two coolant modules (111, 112, 113), an expansion valve, the compressor (163), the at least one evaporator (161), the condenser (162), and the at least one additional module,
wherein the control unit is in the pump housing.

31. A system, comprising:
a heat pump having at least one of: an evaporator (161), a condenser (162), and a compressor (163); and
the distribution module (100) of claim 18, wherein the heat pump is arranged on the distribution module (100).

32. The system of claim 31, wherein the refrigerant circuit is operable using a natural refrigerant comprising propane R-290, propene R-1270, carbon dioxide R-744, or butane R-600, R-600a.

33. The system of claim 31, wherein the heat pump comprises an electric compressor motor for the compressor, the electric compressor motor being operable with a high voltage, the high voltage being greater than 350 Volts (V).

34. A vehicle (300), comprising:
the distribution module (100) of claim 18.
